(19) United States
(12) Patent Application Publication
(10) Pub. No.: US 2025/0172441 A1
(43) Pub. Date: May 29, 2025

(54) OPTICAL FIBER CABLE SKEIN STRUCTURE FOR TEMPERATURE MONITORING, AND SERVER RACK SYSTEM COMPRISING SAME

(71) Applicant: LS ELECTRIC CO., LTD., Anyang-si, Gyeonggi-do (KR)

(72) Inventor: Hyung Suk CHOI, Anyang-si, Gyeonggi-do (KR)

(21) Appl. No.: 18/838,684

(22) PCT Filed: Apr. 27, 2023
(86) PCT No.: PCT/KR2023/005807

§ 371 Date: Aug. 15, 2024

(30) Foreign Application Priority Data
May 25, 2022 (KR) 10-2022-0063962

(51) Int. Cl. G01K 11/32; G01K 1/14

(52) U.S. Cl. CPC G01K 11/32; G01K 1/14

(57) ABSTRACT

The present disclosure provides an optical fiber cable skein structure for temperature monitoring, and a server rack system comprising same, the optical fiber cable skein structure facilitating temperature measurement for a plurality of server modules and comprising: a support unit coupled to an external frame; and a plate unit coupled to the support unit, and arranged to be adjacent to the server modules, wherein the plate unit includes, on the outer circumferential surface thereof, an inner winding member on which an optical fiber cable for sensing the temperature of the server modules is wound.

### TECHNICAL FIELD

The present disclosure relates to an optical fiber cable skein structure for temperature monitoring and a server rack system including the same, and more particularly, to an optical fiber cable skein structure for temperature monitoring that facilitates temperature measurements for a plurality of members and a server rack system including the same.

### BACKGROUND ART

A server refers to a computer or software for providing a service to other computers in a computer network.

With the recent growth of Internet businesses and the increased demand for cloud environments and mobile environments, a demand for servers and Internet data centers (IDCs), which are collections of a plurality of servers, is also continuously increasing.

The servers and IDCs require high specifications and high performances, so heat generation rates during operation are also high. Accordingly, a cooling system is generally provided to prevent overheating of servers and IDCs.

However, when a plurality of servers are aggregated, for example, in the case of an IDC, which is a collection of servers, the focus is only on the physical quantity and power supply of servers, so there is a limit to preparing for heat generation from each server. In particular, a degree of heat generation varies depending on the software and computational operation of each server, thereby making it difficult to actively track the heat generation and provide an optimal state for each server.

Accordingly, there will be a need for the development of an optical fiber cable skein structure for temperature monitoring that can individually track heat generation and actively respond thereto for a server rack system in which a plurality of servers are collected, and a server rack system including the same.

Korean Patent Registration No. 10-1865151 discloses a system for monitoring an internal temperature of a server. Specifically, there is disclosed a system that monitors changes in a server's internal temperature and power consumption and adjusts the server's temperature based thereon.

However, in this type of server, a temperature at a specific location in a server room is directly measured by an administrator, so there is a limit to temperature measurements for respective servers. In addition, there is a possibility that an inaccuracy due to a human inaccuracy may occur during a temperature measurement process.

Korean Patent Registration No. 10-2368592 discloses a temperature simulation modeling method of a data sensor server room. Specifically, there is disclosed a temperature simulation modeling method that improves reliability by comparing an actual measured server room temperature with a computational fluid dynamics (CFD) simulation result.

However, this type of method may only measure a temperature at a specific location in the server room, but has difficulty in collecting temperature information for respective servers. That is, there is a difficulty in collecting accurate heat generation rates in the units of servers.

### DISCLOSURE OF INVENTION

### Technical Problem

An aspect of the present disclosure is to provide an optical fiber cable skein structure for temperature monitoring that facilitates temperature measurements for a plurality of members and a server rack system including the same.

Another aspect of the present disclosure is to provide a fiber optic cable skein structure for temperature monitoring that can further reduce an error and inaccuracy that may occur in a temperature measurement process, and a server rack system including the same.

Still another aspect of the present disclosure is to provide an optical fiber cable skein structure for temperature monitoring in which temperature sensor optical fibers can be variably located in response to server modules of various sizes installed in a rack, and a server rack system including the same.

Problems to be solved by the present disclosure are not limited to the above-mentioned problems, and other problems not mentioned herein will be clearly understood from the following description by those skilled in the art to which the disclosure pertains.

### Solution to Problem

In order to achieve the foregoing objectives, an optical fiber cable skein structure for temperature monitoring according to an embodiment of the present disclosure may include a support portion disposed to extend in one direction, and coupled to one surface of an external frame; and a plate portion disposed to extend in a direction different from the one direction, coupled to the support portion, and disposed adjacent to a server module, wherein the plate portion includes an inner winding member around which an optical fiber cable configured to sense a temperature of the server module is wound on an outer peripheral surface thereof.

Furthermore, the support portion may be provided in plurality to be coupled to the one surface and the other surface of the external frame, respectively, wherein the plate portion is located between the two support portions and coupled to each of the two support portions.

Furthermore, the plate portion may be coupled to the support portions such that its location can be varied between the two support portions along the two support portions.

Furthermore, the plate portion may be provided with a plurality of inner winding members spaced apart from one another, but arranged in parallel along the different direction.

Furthermore, the inner winding member may be disposed with a through hole therein.

Furthermore, fitting portions engaged with and coupled to a portion of the support portion may be disposed at both ends of the plate portion.

Furthermore, the support portion may be provided with a plurality of engagement portions spaced apart from one another on one surface thereof, wherein the plurality of engaging portions are respectively disposed in shapes corresponding to the fitting portions so as to be detachably coupled to the fitting portions, and arranged in parallel along the one direction.

Furthermore, the plate portion may further include an outer winding member spaced apart from the inner winding member, located radially outside the inner winding member, disposed to extend and increase its outer diameter in a direction away from one surface of the plate portion, and disposed to have a maximum outer diameter smaller than that of the inner winding member.

Furthermore, the plate portion may be provided with a cable passage hole disposed to pass through both sides of the plate portion, located in a space between one end of the plate portion and the inner winding member, spaced apart from the inner winding member, and disposed to have an inner diameter larger than an outer diameter of the optical fiber cable.

Furthermore, the cable passage hole may be located in a space between one end opposite to a power source of the plate portion and the inner winding member.

Furthermore, the cable passage hole may be disposed with a protruding portion extending radially inward on an inner peripheral surface thereof.

Furthermore, the support portion may include a first surface extending in the one direction; and a second surface bent to extend from both ends of the first surface toward the external frame.

Furthermore, the first surface may be disposed with a communication hole that is open to an inside and outside of the frame.

Furthermore, a portion of the second surface may be disposed with a coupling hole overlapping with the external frame, wherein the support portion includes a coupling member coupled to pass through the second surface and the external frame, respectively.

In addition, the present disclosure provides a server rack system including a frame portion disposed with an accommodation space partitioned into a plurality of spaces; and a plurality of optical fiber cable skein structures configured to sense a temperature of a server module accommodated in the accommodation space, wherein the server module is accommodated in a withdrawable manner along a length direction of the frame portion in any one of the partitioned accommodation spaces, the cable skein structure includes a plurality of support portions disposed to extend in a withdrawal direction of the server module, and coupled to one surface and the other surface of the frame portion, respectively; and a plate portion accommodated in the accommodation space, disposed to extend in a width direction of the frame portion, located between the two support portions, coupled to each of the two supports, and disposed adjacent to the server module, and the plate portion includes a plurality of inner winding members disposed to extend and increase its outer diameter in a direction away from one surface of the plate portion, around which an optical fiber cable configured to sense a temperature of the server module is wound.

Furthermore, the plate portion may be coupled to the support portions such that its location can be varied between the two support portions along the two support portions.

Furthermore, the support portion may be provided with a plurality of engagement portions arranged in parallel along a withdrawal direction of the server module on one surface thereof, wherein fitting portions engaged with and coupled to any one of the plurality of engagement portions are disposed at both ends of the plate portion.

Furthermore, the inner winding member may extend toward the server module.

Furthermore, one end of the inner winding member may be disposed adjacent to the server module.

Furthermore, a plurality of server modules may be provided, and coupled to different cable skein structures, respectively, wherein the plurality of cable skein structures are electrically connected to one another by the one optical fiber cable.

### Advantageous Effects of Invention

Among various effects of the present disclosure, effects that can be obtained through the foregoing solution means are as follows.

First, an optical fiber cable skein structure for temperature monitoring includes a plurality of support portions and a plate portion located between the two support portions. The plurality of support portions are respectively coupled to an external frame. The plate portion includes an inner winding member disposed adjacent to a server module, around which an optical fiber cable configured to sense the temperature of the server module is wound on an outer peripheral surface thereof.

Therefore, the plate portion comes close to each server module so as to allow heat tracking for the corresponding server module using the optical fiber wound around the plate portion. Accordingly, temperature measurements for a plurality of server modules may be more easily carried out. Furthermore, an administrator may actively respond based on the temperature measurement results for respective server modules, and provide appropriate states to the respective server modules.

In addition, a plurality of cable skein structures are provided and connected to one another other by a single optical fiber cable.

Therefore, an error and inaccuracy that may occur when using a plurality of contact temperature sensors may be further reduced by using a unified temperature sensor optical fiber.

Additionally, an inner winding member protrudes toward a server module and one end thereof is disposed adjacent to the server module, thereby allowing temperature measurements for server modules at different depths. In addition, the plate portion of the cable skein structure is coupled to the support portion such that its location can be varied along the support portion.

Therefore, the location of the plate portion may be freely changed so as to correspond to a length of each server. Accordingly, the cable skein structures may be installed to correspond to servers disposed at different heights and depths.

The effects of the present disclosure are not limited to the above-mentioned effects, and other effects not mentioned herein will be clearly understood from the following description by those skilled in the art to which the disclosure pertains.

### BRIEF DESCRIPTION OF DRAWINGS

FIG. 1 is a perspective view showing a server rack system according to an embodiment of the present disclosure.

FIG. 2 is a perspective view showing a coupling relationship between a server module and a cable skein structure in the server rack system of FIG. 1.

FIG. 3 is a perspective view showing a state in which a cable skein structure is provided in the server rack system of FIG. 1.

FIG. 4 is a perspective view showing a cable skein structure provided in the server rack system of FIG. 1.

FIG. 5 is a front view showing a plate portion provided in the cable skein structure of FIG. 4.

FIG. 6 is a plan view showing the plate portion of FIG. 5.

FIG. 7 is a conceptual diagram showing a coupling relationship between a plate portion and an optical fiber cable.

FIG. 8 is an exploded perspective view showing a support portion provided in the cable skein structure of FIG. 4.

### MODE FOR THE INVENTION

Hereinafter, an optical fiber cable skein structure 200 for temperature monitoring and a server rack system 10 including the same according to an embodiment of the present disclosure will be described in more detail with reference to the drawings.

In the following description, in order to clarify the features of the present disclosure, a description of some elements may be omitted.

In this specification, the same reference numerals are given to the same elements even in different embodiments, and a redundant description thereof will be omitted.

The accompanying drawings are merely illustrated to help easily understand the concept of the present disclosure, and the technical idea disclosed in this specification is not limited by the accompanying drawings.

A singular representation may include a plural representation unless it represents a definitely different meaning from the context.

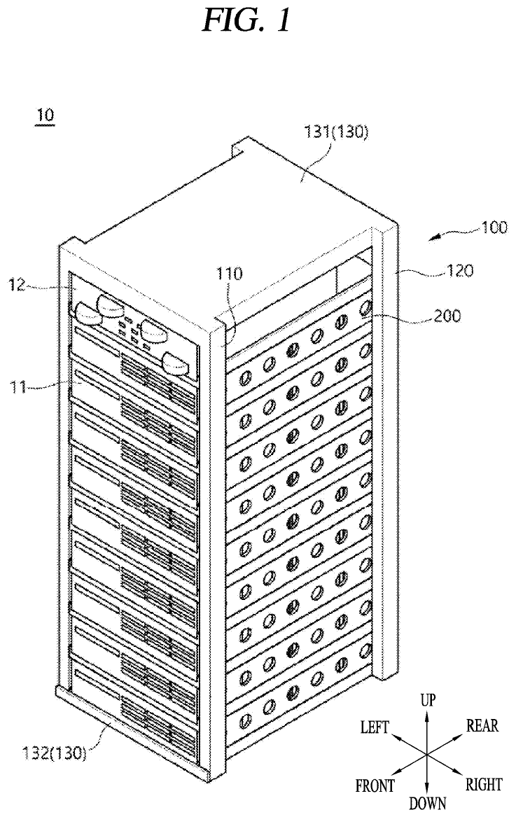

The terms “upper”, “lower”, “left”, “right”, “front” and “rear” used in the following description will be understood with reference to a coordinate system shown in FIG. 1.

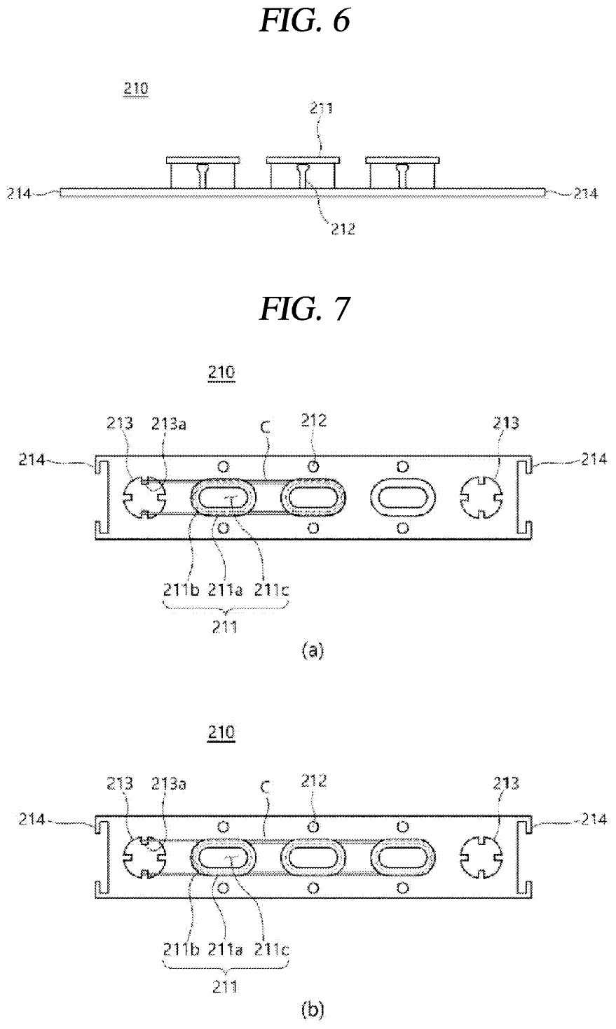

Hereinafter, the server rack system 10 according to an embodiment of the present disclosure will be described with reference to FIGS. 1 to 8.

The server rack system 10 is a server collection body configured to include a plurality of servers, which refer to computers or software for providing a service to other computers in a computer network.

In one embodiment, the server rack system 10 may be an Internet data center (IDC) that is a collection of a plurality of servers.

The server rack system 10 is connected to an external power source to receive power from the external power source or to be charged therefrom.

The server rack system 10 may be provided in any form capable of providing a service to other computers in a computer network.

In the illustrated embodiment, the server rack system 10 has a rectangular pillar shape with an extension length in a front-rear direction greater than that in a left-right direction, and a height in a top-bottom direction. The shape of the server rack system 10 may change depending on the shape of a frame portion 100 that constitutes an external shape of the server rack system 10.

In the illustrated embodiment, the server rack system 10 includes a server module 11, a control module 12, a frame portion 100, and a cable skein structure 200.

Hereinafter, the server module 11, the control module 12, and the frame portion 100 will be described with reference to FIGS. 1 to 3.

The server module 11 may communicate with other computers through a computer network, and provide a service to other computers.

The server module 11 may be provided in a removable manner. Specifically, the server module 11 may be inserted into and coupled to the frame portion 100, which will be described later, in a withdrawable manner. By the coupling, the server module 11 may be electrically connected to an external power source.

The server module 11 may be provided in plurality. Each of the plurality of server modules 11 may individually provide a service to other computers. In one embodiment, each of the plurality of server modules 11 may individually provide a service to different computers.

The plurality of server modules 11 may be electrically coupled to one another. In one embodiment, the electrical connection may be achieved by inserting the server module 11 into the frame portion 100. In the above embodiment, the server module 11 may include an element for electrically connecting the plurality of server modules 11, for example, a busbar.

The server module 11 is electrically connected to the control module 12.

The control module 12 provides a control signal to control the operation of the server module 11. In addition, the control module 12 may sense various information generated according to the operation of the server module 11. For example, the control module 12 may sense a data transmission/reception speed of the server module 11, a transmission/reception target, and the like.

The control module 12 may include various operation units exposed to the outside. In the illustrated embodiment, various buttons, dials, and the like, for the administrator to apply control signals are provided at a front side of the control module 12.

The control module 12 is electrically connected to the server module 11. In an embodiment in which a plurality of server modules 11 are provided, the control module 12 may be electrically connected to each of the plurality of server modules 11.

The control module 12 may be provided in any form capable of inputting, calculating, outputting, and storing information. In one embodiment, the control module 12 may include members for information processing, such as a CPU and a microprocessor, and members for storing information, such as a RAM, a ROM, an SSD, an HDD, and an SD card.

In one embodiment, the control module 12 may be electrically connected to an external terminal (not shown). Information sensed by the control module 12 may be transmitted to an external terminal. Additionally, the administrator may apply a control signal from the control module 12 through an external terminal.

The server module 11 and the control module 12 are respectively coupled to the frame portion 100 in a removable manner.

The frame portion 100 constitutes an exterior of the server rack system 10.

A space is formed inside the frame portion 100 such that the server module 11 and the control module 12 can be accommodated in a withdrawable manner.

The frame portion 100 may receive the server module 11 and the control module 12 in a withdrawable manner, and may be provided in any form that can be coupled to the cable skein structure 200. In the illustrated embodiment, similar to the external shape of the server rack system 10, the frame portion 100 is formed in a rectangular pillar shape with an extension length in a front-rear direction greater than that in a left-right direction, and a height in a top-bottom direction.

The frame portion 100 may be made of a lightweight, yet highly rigid material. For example, the frame portion 100 may be formed of a steel alloy material. This is to stably support the server module 11 and the control module 12 coupled to each other.

In the illustrated embodiment, the frame portion 100 includes a first frame 110, a second frame 120, a cover portion 130, and an accommodation space 140.

The first frame 110 constitutes part of an exterior of the frame portion 100. In the illustrated embodiment, the first frame 110 constitutes a front exterior of the frame portion 100.

The first frame 110 extends in a height direction of the frame portion 100. In the illustrated embodiment, the first frame 110 extends in a top-bottom direction.

The first frame 110 is coupled to the cover portion 130. Specifically, one end and the other end of the first frame 110 are respectively coupled to the first cover 131 and the second cover 132, which will be described later. In the illustrated embodiment, upper and lower ends of the first frame 110 are coupled to the first cover 131 and the second cover 132, respectively.

The first frame 110 may be provided in plurality. In one embodiment, the plurality of first frames 110 may be disposed to be spaced apart in a width direction of the frame portion 100. In the illustrated embodiment, a pair of first frames 110 are provided, and disposed to be spaced apart from each other in a left-right direction.

As the plurality of first frames 110 are spaced apart, an opening portion may be formed. The opening portion communicates with the accommodation space 140, which will be described later. The server module 11 or the control module 12 may be inserted into or withdrawn from the server rack system 10 through the opening portion.

In addition, the first frame 110 is a portion to which the support portion 220 of the cable skein structure 200, which will be described later, is coupled. A detailed description thereof will be described later along with a description of the cable skein structure 200.

The first frame 110 is disposed to be spaced apart from the second frame 120 in a length direction of the frame portion 100. In the illustrated embodiment, the first frame 110 is disposed to be spaced apart from the second frame 120 in a front-rear direction.

The second frame 120 constitutes another part of an exterior of the frame portion 100. In the illustrated embodiment, the second frame 120 constitutes a rear exterior of the frame portion 100.

The second frame 120 disposed to extend in a height direction of the frame portion 100. That is, the second frame 120 is disposed to extend in the same direction as that of the first frame 110. In the illustrated embodiment, the second frame 120 extends in a top-bottom direction.

The second frame 120 is coupled to the cover portion 130. Specifically, one end and the other end of the first frame 120 in an extension direction are respectively coupled to the first cover 131 and the second cover 132, which will be described later. In the illustrated embodiment, upper and lower ends of the second frame 120 are coupled to the first cover 131 and the second cover 132, respectively.

The second frame 120 may be provided in plurality. In one embodiment, the plurality of second frames 120 may be disposed to be spaced apart in a width direction of the frame portion 100. In the illustrated embodiment, a pair of second frames 120 are provided, and disposed to be spaced apart from each other in a left-right direction.

As the plurality of second frames 120 are spaced apart, an opening portion may be formed. The opening portion communicates with the accommodation space 140, which will be described later. Heat generated in the server module 11 or the control module 12 may be discharged to the outside through the opening portion. Additionally, a conductive member (not shown) for electrically connecting the server module 11 or the control module 12 to an external power source or terminal may be coupled through the opening portion.

The cover portion 130 constitutes another part of an exterior of the frame portion 100. In the illustrated embodiment, the cover portion 130 constitutes an upper and lower exterior of the frame portion 100.

The cover portion 130 is located at each end portion of the frame portion 100 in a height direction.

The cover portion 130 is disposed to cover a space formed inside the frame portion 100. Specifically, the cover portion 130 is disposed to cover the uppermost and lowermost accommodation spaces 140 among the accommodation spaces 140 formed inside the frame portion 100.

The cover portion 130 may be provided in plurality. The plurality of cover portions 130 may be disposed to be spaced apart in a height direction of the frame portion 100. In the illustrated embodiment, the cover portion 130 includes a first cover 131 and a second cover 132 in pair. In the above embodiment, the first cover 131 and the second cover 132 are disposed to be spaced apart in a top-bottom direction.

The cover portion 130 is coupled to an end portion in an extension direction of each of the first frame 110 and the second frame 120. In the illustrated embodiment, the first cover 131 is coupled to tops of the first frame 110 and the second frame 120, respectively, and the second cover 132 is coupled to bottoms of the first frame 110 and the second frame 120, respectively.

A space formed by allowing the plurality of cover portions 130, that is, the first cover 131 and the second cover 132, to be spaced apart from each other, is defined as the accommodation space 140.

The accommodation space 140 functions as a space to accommodate the server module 11 and the control module 12. The server module 11 and the control module 12 may be inserted into the accommodation space 140 in a withdrawable manner along a length direction of the frame portion 100.

The accommodation space 140 may be defined by being surrounded by the first frame 110, the second frame 120, and the cover portion 130.

In the illustrated embodiment, a front side of the accommodation space 140 is partially surrounded by the first frame 110. A rear side of the accommodation space 140 is partially surrounded by the second frame 120. Upper and lower sides of the accommodation space 140 are surrounded by the first cover 131 and the second cover 132, respectively.

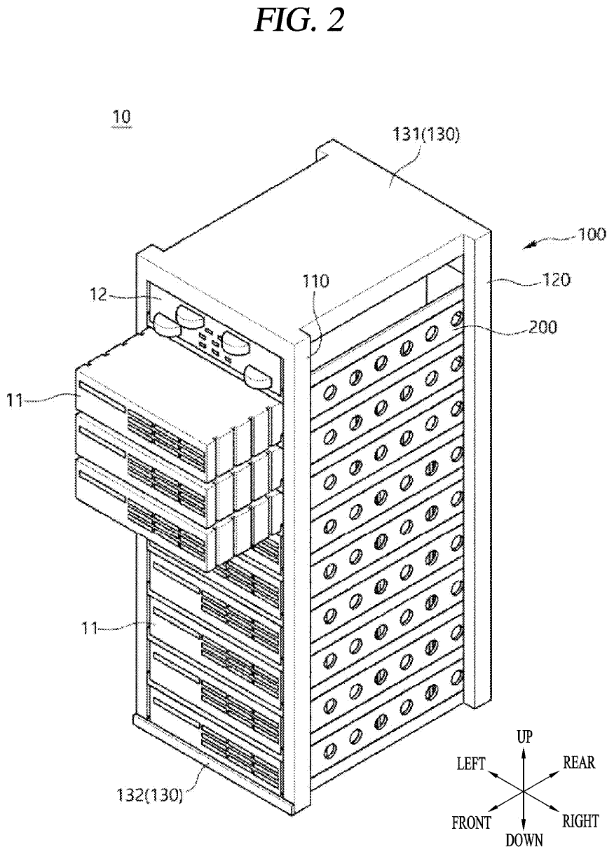

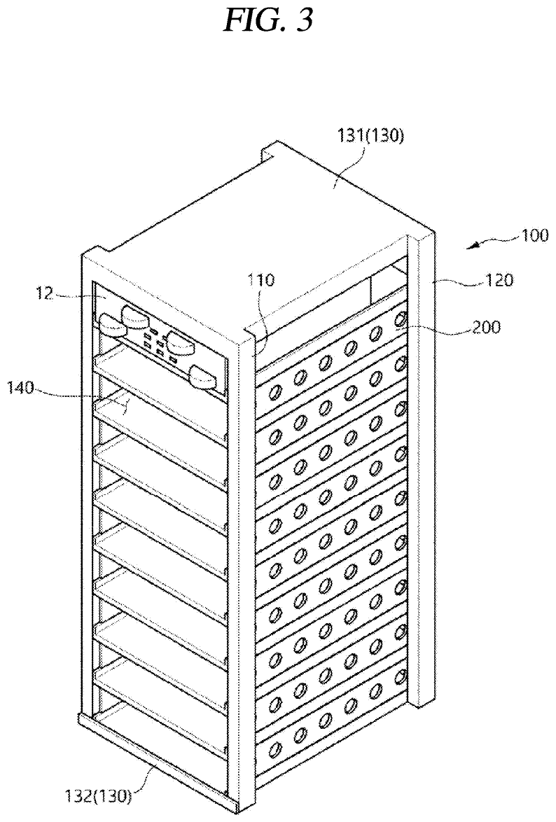

The accommodation space 140 communicates with the outside. The server module 11 and the control module 12 may be accommodated in or withdrawn from the accommodation space 140 through a portion of the accommodation space 140 that communicates with the outside. In the illustrated embodiment, the server module 11 and the control module 12 may be accommodated in or withdrawn from the accommodation space 140 through a front side of the accommodation space 140 (see FIGS. 2 and 3).

The accommodation space 140 may be formed in a shape corresponding to the frame portion 100. In the illustrated embodiment, the accommodation space 140 is disposed to have an extension length in a front-rear direction greater than that in a left-right direction, and a height in a top-bottom direction.

The accommodation space 140 may be partitioned into a plurality of spaces. Specifically, the accommodation space 140 may be partitioned into a plurality of spaces along its height direction. That is, the frame portion 100 is configured with a rack structure having a plurality of accommodation spaces 140.

A plurality of server modules 11 or control modules 12 may be accommodated in the plurality of spaces, respectively, in a withdrawable manner. To this end, the accommodation space 140 is preferably formed in a shape corresponding to the server module 11 or the control module 12. In the illustrated embodiment, the accommodation space 140 is partitioned into a plurality of spaces along a top-bottom direction.

In general, a width direction length of the server module 11 is disposed to be constant according to a standard specification, but its height and depth may be disposed in various ways. As described above, the accommodation space 140 corresponds to the server module 11 or the control module 12, and the accommodation space 140 may also have various heights and depths.

Here, it is to be understood that an upper side of the uppermost accommodation space 140 among the plurality of partitioned accommodation spaces 140 is surrounded by the first cover 131, and a lower side of the lowermost accommodation space 140 is surrounded by the second cover 132.

The frame portion 100 is coupled to the optical fiber cable skein structure 200 that can individually measure a temperature of the server module 11 inserted into each accommodation space 140.

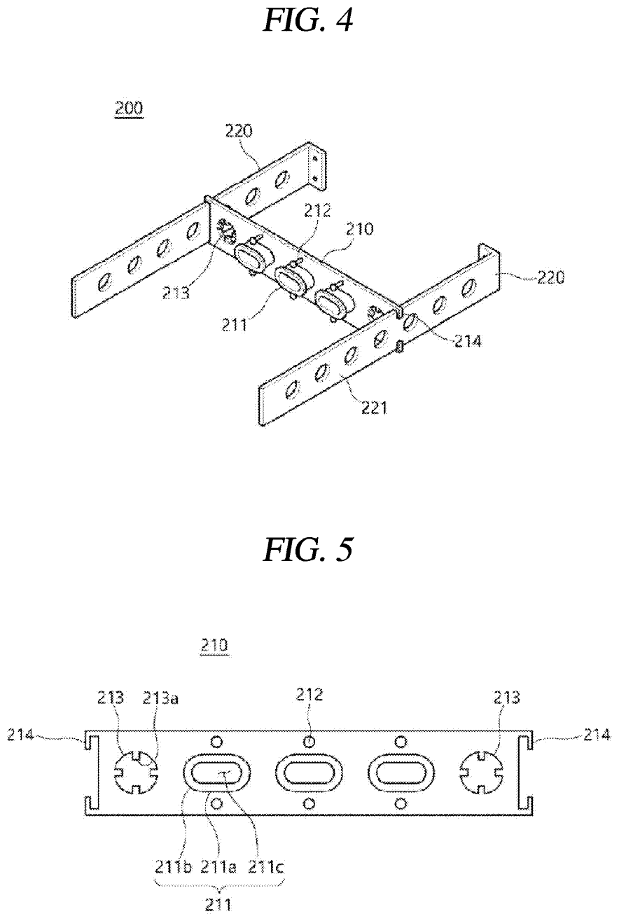

Hereinafter, the cable skein structure 200 will be described with reference to FIGS. 4 to 8.

The cable skein structure 200 is provided in the server rack system 10 and configured to collect temperature data of the server module 11. Specifically, the cable skein structure 200 assists the installation of an optical fiber cable C to facilitate temperature measurements of the plurality of server modules 11 in accordance with the frame portion 100 of a standardized rack structure.

In one embodiment, the cable skein structure 200 may measure a temperature of the server module 11 and its surrounding environment using a cable C formed in the form of an optical fiber. The process of measuring a temperature using an optical fiber is a well-known technology, and thus a detailed description thereof will be omitted.

The cable skein structure 200 is disposed to surround a portion of the server module 11, which is a temperature measurement target. In the illustrated embodiment, the cable skein structure 200 is disposed to surround the left, right, and rear sides of the server module 11, which is a temperature measurement target.

The cable skein structure 200 is coupled to the frame portion 100. In one embodiment, the cable skein structure 200 may be fixedly coupled to or integrally configured with the frame portion 100.

The cable skein structure 200 may be electrically connected to an external terminal (not shown) to transmit the collected temperature data to the external terminal or the like. Accordingly, the administrator may easily collect temperature information of the server rack system 10.

The cable skein structure 200 may be provided in plurality. Here, the plurality of cable skein structures 200 are coupled to different server modules 11, respectively.

Accordingly, the cable skein structures 200 carry out individual and independent heat tracking for the respective server modules 11. Accordingly, temperature measurements for the plurality of server modules 11 may be more easily carried out. Furthermore, an administrator may actively respond based on the temperature measurement results for the respective server modules 11, and provide appropriate states to the respective server modules 11.

Additionally, as temperature data for respective servers is collected, a larger amount of temperature data may be collected. Accordingly, the reliability of the temperature measurement results of the cable skein structures 200 may be further improved.

In one embodiment, the plurality of cable skein structures 200 may be connected to one another by one optical fiber cable C. Therefore, an error and inaccuracy that may occur when using a plurality of contact temperature sensors may be further reduced by using a unified temperature sensor optical fiber.

The plurality of cable skein structures 200 may be disposed to be spaced apart from one another in a height direction of the frame portion 100. In the illustrated embodiment, the plurality of cable skein structures 200 are disposed to be spaced apart from one another in a top-bottom direction.

In the illustrated embodiment, the cable skein structure 200 includes a plate portion 210 and a support portion 220.

Hereinafter, the plate portion 210 will be described with reference to FIGS. 4 to 7.

The plate portion 210 is a portion that directly measures a temperature of the server module 11.

The plate portion 210 is disposed adjacent to the server module 11. In one embodiment, the plate portion 210 may be disposed adjacent to a rear side of the server module 11.

The plate portion 210 is disposed in the accommodation space 140 of the frame portion 100. To this end, preferably, the lengths of the plate portion 210 in top-bottom, left-right, and front-rear directions are respectively disposed to be smaller than those of the accommodation space 140 in the top-bottom, left-right, and front-rear directions.

Additionally, the plate portion 210 is located between two support portions 220, which will be described later. Specifically, the plate portion 210 is coupled to the two support portions 220 such that its location can be varied between the two support portions 220 along the two support portions 220.

Therefore, the location of the plate portion 210 may be freely changed corresponding to a length of each server module 11. Accordingly, the cable skein structure 200 may be installed to correspond to servers having various lengths.

The plate portion 210 is disposed to extend in a width direction of the frame portion 100. In the illustrated embodiment, the plate portion 210 is disposed to extend in a left-right direction.

In the illustrated embodiment, the plate portion 210 is provided with an inner winding member 211, an outer winding member 212, a cable passage hole 213, and a fitting portion 214.

The inner winding member 211 provides a space for winding the optical fiber cable C for measuring temperatures.

The optical fiber cable C formed in the form of an optical fiber requires a measurement interval above a predetermined length for more accurate temperature measurements. This is because the center that receives temperature data estimates a temperature with a predetermined error range, and a temperature estimation algorithm is set to estimate the temperature at regular intervals along the optical fiber cable C.

Therefore, in order to measure the temperatures of a plurality of points located in a short distance, it is necessary to increase an overall length of the optical fiber cable C through winding. The inner winding member 211 is a portion around which the optical fiber cable C is wound.

The inner winding member 211 may be provided in plurality. This is to more easily adjust an extension length of the optical fiber cable C according to the server module 11 subject to temperature measurement according to a temperature sensing sensitivity, or the like. In the illustrated embodiment, three inner winding members 211 are provided. However, the inner winding member 211 is not limited to the illustrated embodiment, and four or more inner winding members 211 may be provided.

In one embodiment, the plurality of inner winding members 211 may be spaced apart from one another, and arranged in parallel along an extension direction of the plate portion 210.

When the plurality of inner winding members 211 are provided, the optical fiber cable C for temperature sensing may be wound around at least part of the plurality of inner winding members 211. For example, when three winding members are provided, the optical fiber cable C may be wound only around the two inner winding members 211 on the left side (see (a) of FIG. 7). In addition, the optical fiber cable C may be wound around all three inner winding members 211 (see (b) of FIG. 7).

Here, a number of inner winding members 211 around which the optical fiber cable C is wound may be appropriately selected depending on the server module 11, which is a temperature measurement target, and a temperature sensing sensitivity.

The inner winding member 211 is disposed on one surface of the plate portion 210.

The inner winding member 211 is disposed to extend in a direction away from the one surface of the plate portion 210. Here, the inner winding member 211 is disposed to extend its outer diameter in a direction away from the plate portion 210.

In one embodiment, the inner winding member 211 may be disposed to extend toward the server module 11. In another embodiment, one end of the inner winding member 211 may be disposed adjacent to the server module 11.

An optical fiber cable C configured to sense a temperature of the server module 11 is wound around an outer peripheral surface of the inner winding member 211. Here, an outer diameter of the inner winding member 211 is preferably configured to be a multiple of the measurement interval of the optical fiber cable C. This is to easily adjust a number of windings of the optical fiber cable C in response to a target temperature measurement location.

The inner winding member 211 may be formed in any shape that allows the optical fiber cable C to be wound stably. In the illustrated embodiment, the inner winding member 211 includes a pair of flat portions 211a and a pair of curved portions 211b that are respectively continuous with and the pair of flat portions 211a and rounded to be convex toward the outside.

The flat portions 211a respectively extend in a horizontal direction, that is, a left-right direction in the illustrated embodiment. A pair of the flat portions 211a are provided, and the pair of flat portions 211a are disposed to face each other while being spaced apart in a height direction of the plate portion 210. In the illustrated embodiment, the pair of flat portions 211a are disposed to face each other while being spaced apart in a top-bottom direction.

The pair of flat portions 211a are respectively continuous with the pair of curved portions 211b.

The curved portion 211b is disposed to be round and convex toward an outer side of the flat portion 211a in an extension direction. A pair of curved portions 211b are provided, and are continuous with respective end portions of the flat portion 211a in an extension direction. The pair of curved portions 211b are disposed to be spaced apart in an extension direction in which the flat portion 211a so as to face each other. In the illustrated embodiment, the pair of curved portions 211b are disposed to face each other while being spaced apart in a left-right direction.

Additionally, in the illustrated embodiment, the pair of curved portions 211b are continuous with left and right end portions of the flat portion 211a, respectively. In the above embodiment, a radius of curvature of the curved portion 211b is preferably disposed to be small enough to prevent damage to the wound optical fiber cable C.

A through hole 211c is disposed in the center of the pair of flat portions 211a and the pair of curved portions 211b.

The through hole 211c is open to front and rear sides of the inner winding member 211 to provide a space for dissipating heat generated from the server module 11.

The through hole 211c is located radially inside the inner winding member 211.

The through hole 211c extends in the same direction as an extension direction of the inner winding member 211. In the illustrated embodiment, the through hole 211c extends in a front-rear direction.

The outer winding member 212 is disposed on one surface of the plate portion 210 that is spaced apart from the inner winding member 211.

The outer winding member 212 increases a temperature measurement accuracy of the cable skein structure 200 by branching the optical fiber cable C remaining after being wound around the inner winding member 211.

The outer winding member 212 is spaced apart from the inner winding member 211, and is located radially outside the inner winding member 211.

The outer winding member 212 is disposed on one surface of the plate portion 210. The outer winding member 212 extends with its outer diameter that increases in a direction away from the one surface. In one embodiment, a maximum inner diameter of the outer winding member 212 may be disposed to be smaller than a maximum outer diameter of the inner winding member 211.

The cable passage hole 213 may be disposed in a space between one end of the plate portion 210 and the inner winding member 211.

The cable passage hole 213 provides an inlet space for the optical fiber cable C coupled to the cable skein structure 200.

The cable passage hole 213 passes through both sides of the plate portion 210.

An inner diameter of the cable passage hole 213 is disposed to be larger than an outer diameter of the optical fiber cable C. It is to be understood that this is to facilitate the introduction of the optical fiber cable C.

The cable passage hole 213 may be disposed with a protruding portion 213a on an inner peripheral surface thereof.

The protruding portion 213a is disposed to extend radially inward from an inner peripheral surface of the cable passage hole 213.

The accuracy of temperature measurement is increased by branching the optical fiber cable C remaining after being wound around the inner winding member 211 or the outer winding member 212 on the protruding portion 213a. Specifically, the protruding portion 213a adjusts an interval of the optical fiber cable C in such a manner that the interval between an end point of winding of the optical fiber cable C on one plate portion 210 and a start point of winding of the optical fiber cable C on the other plate portion 210 becomes a multiple of the measurement interval of the optical fiber cable C.

The protruding portion 213a may be provided in plurality. In the illustrated embodiment, four protruding portions 213a are provided on an inner peripheral surface of one cable passage hole 213.

In one embodiment, the cable passage hole 213 may be disposed in a space between either a left or a right end portion of the plate portion 210 and the inner winding member 211. In the above embodiment, the cable passage hole 213 is preferably located in a space between the inner winding member 211 and one end portion of the plate portion 210 opposite to a power source. This is to simulate a room temperature prior to the heat generation of the server module 11 as accurately as possible.

In another embodiment, the cable passage hole 213 may be disposed in a space between a left end portion of the plate portion 210 and the inner winding member 211 and a space between a right end portion of the plate portion 210 and the inner winding member 211, respectively.

Additionally, the cable passage hole 213 is spaced apart from the inner winding member 211 and the outer winding member 212.

The fitting portions 214 are disposed at both ends of the plate portion 210.

The fitting portion 214 is a portion where the plate portion 210 is directly coupled to the support portion 220, which will be described later.

The fitting portion 214 is engaged with and coupled to a portion of the support portion 220. To this end, the fitting portion 214 may be disposed in any shape corresponding to the portion of the support portion 220. In the illustrated embodiment, the fitting portion 214 is disposed to surround a portion of the support portion 220.

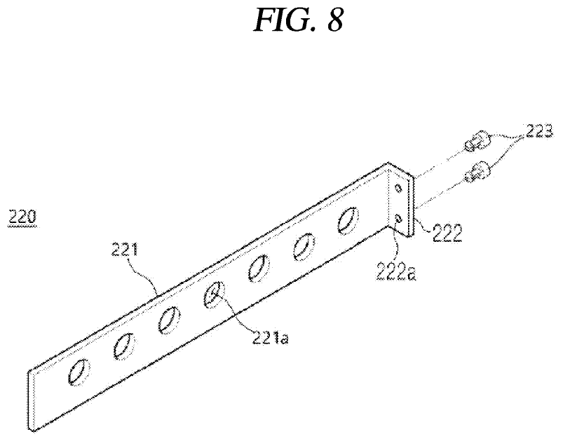

Hereinafter, the support portion 220 will be described in more detail with reference to FIG. 8.

The support portion 220 fixes the plate portion 210 and the frame portion 100 at a specific location.

The support portion 220 is coupled to one surface and the other surface of the frame portion 100, respectively. In one embodiment, the support portion 220 may be coupled to left and right side surfaces of the frame portion 100, respectively. In the above embodiment, the support portion 220 may be coupled to the first frame 110 and the second frame 120, respectively.

The support portion 220 may be provided in plurality. In the illustrated embodiment, the two support portions 220 are disposed to face each other with the plate portion 210 interposed therebetween.

The support portion 220 is disposed to extend along a length direction of the frame portion 100, that is, a direction in which the server module 11 is withdrawn. In the illustrated embodiment, the support portion 220 extends in a front-rear direction.

The support portion 220 may be coupled to the plate portion 210 and may be provided in any shape capable of supporting it. Here, the plate portion 210 is coupled to the support portion 220 such that its location can be varied along an extension direction of the support portion 220 between the two support portions 220.

Therefore, the cable skein structure 200 may be installed to correspond to the server module 11 disposed at different heights and depths. Accordingly, temperature measurements for the server modules 11 at different depths is facilitated.

In the illustrated embodiment, support 220 includes a first surface 221 and a second surface 222.

The first surface 221 is formed in a plate shape extending in the same direction as an extension direction of the support portion 220.

The first surface 221 is coupled to one surface and the other surface of the frame portion 100, respectively. (“

[symbol]

In one embodiment, a plurality of engagement portions spaced apart from one another may be disposed on the first surface 221. In the above embodiment, the engagement portion is formed in a shape corresponding to the fitting portion 214 so as to be detachably coupled to the fitting portion 214. The engagement portion may be disposed in a recessed or protruding manner with respect to the first surface 221. Additionally, a plurality of the engagement portions are arranged in parallel in a front-rear direction.

A communication hole 221a that is open to an inside and outside of the frame portion 100 may be disposed in a portion of the first surface 221.

The second surface 222 is disposed at one end of the support portion 220.

The second surface 222 is bent and disposed to extend from one end of the support portion 220 toward the frame portion 100, respectively. In the illustrated embodiment, the second surface 222 is bent at 90 degrees with respect to the first surface 221 to extend.

A coupling hole 222a may be disposed in a portion of the second surface 222.

The coupling hole 222a is disposed in a portion of the second surface 222 to overlap the frame portion 100. In one embodiment, the coupling hole 222a may be disposed to overlap either one of the first frame 110 and the second frame 120.

A coupling member 223 may be inserted into the coupling hole 222a.

The coupling member 223 is coupled to pass through the second surface 222 of the support portion 220 and the frame portion 100, respectively, thereby further strengthening a coupling between the support portion 220 and the frame portion 100, and supporting a coupling portion therebetween.

The coupling member 223 may be disposed in any shape capable of coupling the support portion 220 and the frame portion 100 to each other. In one embodiment, an engagement portion extending radially outward from the coupling hole 222a may be disposed at one end of the coupling member 223.

Although the present disclosure has been described above with reference to preferred embodiments, the present disclosure is not limited to the configurations of the above-described embodiments.

In addition, it should be understood that the present disclosure can be modified and changed in various ways by those skilled in the art to which the present disclosure pertains without departing from the concept and scope of the present disclosure described in the claims below.

Furthermore, all or some of those embodiments may be selectively combined so that various modifications can be made.

1. An optical fiber cable skein structure for temperature monitoring, the structure comprising:
a support portion disposed to extend in one direction, and coupled to one surface of an external frame; and
a plate portion disposed to extend in a direction different from the one direction, coupled to the support portion, and disposed adjacent to a server module,
wherein the plate portion comprises an inner winding member around which an optical fiber cable configured to sense a temperature of the server module is wound on an outer peripheral surface thereof.

2. The structure of claim 1, wherein the support portion is provided in plurality to be coupled to the one surface and the other surface of the external frame, respectively, and
wherein the plate portion is located between the two support portions and coupled to each of the two support portions.

3. The structure of claim 2, wherein the plate portion is coupled to the support portions such that its location can be varied between the two support portions along the two support portions.

4. The structure of claim 1, wherein the plate portion is provided with a plurality of inner winding members spaced apart from one another, but arranged in parallel along the different direction.

5. The structure of claim 1, wherein the inner winding member is disposed with a through hole therein.

6. The structure of claim 1, wherein fitting portions engaged with and coupled to a portion of the support portion are disposed at both ends of the plate portion.

7. The structure of claim 6, wherein the support portion is provided with a plurality of engagement portions spaced apart from one another on one surface thereof, and
wherein the plurality of engaging portions are respectively disposed in shapes corresponding to the fitting portions so as to be detachably coupled to the fitting portions, and arranged in parallel along the one direction.

8. The structure of claim 1, wherein the plate portion further comprises an outer winding member spaced apart from the inner winding member, located radially outside the inner winding member, disposed to extend and increase its outer diameter in a direction away from one surface of the plate portion, and disposed to have a maximum outer diameter smaller than that of the inner winding member.

9. The structure of claim 1, wherein the plate portion is provided with a cable passage hole disposed to pass through both sides of the plate portion, located in a space between one end of the plate portion and the inner winding member, spaced apart from the inner winding member, and disposed to have an inner diameter larger than an outer diameter of the optical fiber cable.

10. The structure of claim 9, wherein the cable passage hole is located in a space between one end opposite to a power source of the plate portion and the inner winding member.

11. The structure of claim 9, wherein the cable passage hole is disposed with a protruding portion extending radially inward on an inner peripheral surface thereof.

12. The structure of claim 1, wherein the support portion comprises:
a first surface extending in the one direction; and
a second surface bent to extend from both ends of the first surface toward the external frame.

13. The structure of claim 12, wherein the first surface is disposed with a communication hole that is open to an inside and outside of the frame.

14. The structure of claim 12, wherein a portion of the second surface is disposed with a coupling hole overlapping with the external frame, and
wherein the support portion comprises a coupling member coupled to pass through the second surface and the external frame, respectively.

15. A server rack system comprising:
a frame portion disposed with an accommodation space partitioned into a plurality of spaces; and
a plurality of optical fiber cable skein structures configured to sense a temperature of a server module accommodated in the accommodation space,
wherein the server module is accommodated in a withdrawable manner along a length direction of the frame portion in any one of the partitioned accommodation spaces,
wherein the cable skein structure comprises:
a plurality of support portions disposed to extend in a withdrawal direction of the server module, and coupled to one surface and the other surface of the frame portion, respectively; and
a plate portion accommodated in the accommodation space, disposed to extend in a width direction of the frame portion, located between the two support portions, coupled to each of the two supports, and disposed adjacent to the server module, and
wherein the plate portion comprises a plurality of inner winding members disposed to extend and increase its outer diameter in a direction away from one surface of the plate portion, around which an optical fiber cable configured to sense a temperature of the server module is wound.

16. The server rack system of claim 15, wherein the plate portion is coupled to the support portions such that its location can be varied between the two support portions along the two support portions.

17. The server rack system of claim 16, wherein the support portion is provided with a plurality of engagement portions arranged in parallel along a withdrawal direction of the server module on one surface thereof, and
wherein fitting portions engaged with and coupled to any one of the plurality of engagement portions are disposed at both ends of the plate portion.

18. The server rack system of claim 15, wherein the inner winding member extends toward the server module.

19. The server rack system of claim 18, wherein one end of the inner winding member is disposed adjacent to the server module.

20. The server rack system of claim 15, wherein a plurality of server modules are provided, and coupled to different cable skein structures, respectively, and
wherein the plurality of cable skein structures are connected to one another by the one optical fiber cable.
